(19) United States
(12) Patent Application Publication
(10) Pub. No.: US 2016/0306132 A1
(43) Pub. Date: Oct. 20, 2016

(54) LENS BARREL AND ELECTRONIC DEVICE HAVING THE SAME

(71) Applicant: Samsung Electronics Co., Ltd., Gyeonggi-do (KR)

(72) Inventors: Chang-Bae LEE, Seoul (KR); Soo-Jung KIM, Gyeongsangnam-do (KR); Hwan-Soo PARK, Gyeonggi-do (KR); Ki-Yun JO, Gyeonggi-do (KR); Ji-Yeon JO, Gyeonggi-do (KR)

(21) Appl. No.: 15/098,407

(22) Filed: Apr. 14, 2016

(30) Foreign Application Priority Data
Apr. 16, 2015 (KR) 10-2015-0053896

(51) Int. Cl. G02B 7/00; H04N 5/225; G03B 17/14; G02B 13/00; G02B 7/02; G02B 7/04

(52) U.S. Cl. CPC G02B 7/003; G02B 7/021; G02B 7/04; G02B 7/023; G03B 17/14; G02B 13/002; G02B 13/009; H04N 5/2252; H04N 5/2254

(57) ABSTRACT

A lens barrel may be detachably coupled to a capturing device may comprise a first lens assembly having first lenses mounted therein. A second lens assembly may be coupled to the first lens assembly and may have second lenses mounted therein. The second lenses may be aligned with the first lenses along an optic axis, and an adjusting portion may be provided in the first lens assembly and may be configured to adjust a position of the first lenses relative to the second lenses along a direction the optic axis by an electromagnetic force.

### CLAIM OF PRIORITY

This application claims the benefit under 35 U.S.C. §119(a) of Korean patent application Serial No. 10-2015-0053896 filed in the Korean Intellectual Property Office on Apr. 16, 2015, the entire disclosure of which is hereby incorporated herein by reference.

### TECHNICAL FIELD

The present disclosure generally relates to lens barrels, and more particularly to lens barrels that are used in electronic devices.

### DISCUSSION OF RELATED ART

A lens barrel is equipped in a camera to obtain images of an object and includes lenses for forming images of the object and lens assemblies for accommodating the lenses. The lens barrel may change the range of the object of which a picture is to be taken while the camera remains stationary. The lens assemblies are moved along the optic axis, allowing the lenses to zoom in/out for adjusting the magnification of the object and to focus the object.

Such lenses may be formed of glass or plastics. When performance comes first, glass lenses are widely used as they tend to offer a clearer image. Plastic lenses boast light weight, high rigidity, low costs, and easiness to mass production. Plastic lenses exhibit a low transmittance and refractive index as compared with glass lenses, but the recent development of the material is narrowing such gap.

More attention is directed to allowing lens barrels more compact and cost savings. In applying plastic aspheric lenses to a lens barrel, it is not easy to align the optic axes of the lenses when putting the lenses in the lens barrel. Further, it is difficult to align the optic axes of lenses installed in a compact lens barrel upon zooming.

The above information is presented as background information only to assist with an understanding of the present disclosure. No determination has been made, and no assertion is made, as to whether any of the above might be applicable as prior art with regard to the present disclosure.

### SUMMARY

According to an embodiment of the present disclosure, there is provided a lens barrel that may be made compact by using multiple plastic aspheric lenses that may be aligned with one another along the optic axes of the lenses.

According to an embodiment of the present disclosure, there is provided a lens barrel that may align the optic axes of multiple lenses while zooming is achieved by the lenses in the lens barrel.

According to an embodiment of the present disclosure, a lens barrel may be detachably coupled to a capturing device, and the lens barrel may include: a first lens assembly having at least one first lens mounted therein; and a second lens assembly coupled with the first lens assembly and having at least one second lens mounted therein, the at least one second lens being aligned with the at least one first lens along an optic axis. The first lens assembly includes an adjusting portion, the adjusting portion being configured to adjust a position of the at least one first lens relative to the at least one second lens along the optic axis by an electromagnetic force.

An electronic device may include a lens barrel detachably coupled to a capturing device, the lens barrel comprising: a first lens assembly having at least one first lens mounted therein; a second lens assembly coupled with the first lens assembly and having at least one second lens mounted therein, the at least one second lens being aligned with the at least one first lens along an optic axis. The first lens assembly may include an adjusting portion, the adjusting portion being configured to adjust a position of the at least one first lens relative to the at least one second lens along the optic axis by an electromagnetic force. The first lens assembly may include: a lens module having the at least one first lens mounted therein; a housing accommodating the lens module and configured to facilitate movement of the lens module along the direction of the optic axis and having a first opening at a side thereof; and a guide portion coupled within the first opening of the housing. The adjusting portion may include: a magnet mounted on an outer wall of the lens module; and a coil mounted on the guide portion, wherein the lens module is movable in the housing by an electromagnetic force generated by the magnet and the coil. A second opening may be formed in the second lens assembly, and an aligning device may be positioned within the second opening that is configured to adjust and align a position of the first lens assembly relative to the second lens. The first lens assembly may include at least one of a guide hole and a guide protrusion, and wherein the least one of the guide hole and the guide protrusion guides the aligning device to a position where the aligning device holds the first lens assembly. A circuit portion may be provided in the second lens assembly to drive the adjusting portion. The circuit portion may be disposed between parallel surfaces of the first lens assembly of the second lens assembly. A third opening may be formed in the second lens assembly; and a connecting portion may be electrically connecting an electronic device with the circuit portion through the third opening. The electronic device may further include a casing, wherein the lens barrel is detachably coupled to the casing. The electronic device may further include a connection terminal disposed on an outer surface of the casing, wherein the connection terminal is electrically connected with the lens barrel.

These and other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exploded perspective view illustrating a lens barrel according to an embodiment of the present disclosure;

FIG. 2 is a perspective view illustrating an example in which a lens barrel is assembled according to an embodiment of the present disclosure;

FIG. 3 is an exploded perspective view illustrating a first lens assembly of a lens barrel according to an embodiment of the present disclosure;

FIG. 4 is an exploded perspective view illustrating a second lens assembly of a lens barrel according to an embodiment of the present disclosure;

FIG. 5 is a perspective view illustrating an example in which a first lens assembly and second lens assembly of a lens barrel are arranged in an optic axis direction according to an embodiment of the present disclosure;

FIG. 6 is a plan view illustrating a first lens assembly of a lens barrel according to an embodiment of the present disclosure;

FIG. 7 is a front view illustrating a first lens assembly of a lens barrel according to an embodiment of the present disclosure;

FIG. 8 is a perspective view illustrating an example in which a guide portion is separated from a first lens assembly of a lens barrel according to an embodiment of the present disclosure;

FIG. 9 is a plan view illustrating an example in which a first lenses are assembled in a first lens assembly of a lens barrel according to an embodiment of the present disclosure;

FIG. 10 is a cross-sectional view illustrating a first lens assembly of a lens barrel according to an embodiment of the present disclosure;

FIG. 11 is a perspective view illustrating an example a first lens assembly is assembled with a second lens assembly of a lens barrel according to an embodiment of the present disclosure;

FIG. 12 is a perspective view illustrating an example in which an aligning device is coupled to a first lens assembly of a lens barrel according to an embodiment of the present disclosure;

FIG. 13 is a perspective view illustrating an example in which an arm of the aligning device of FIG. 12 is inserted through a first opening of a second lens assembly;

FIG. 14 is a perspective view illustrating an example in which a circuit portion is assembled to a second lens assembly of a lens barrel according to an embodiment of the present disclosure; and

FIG. 15 is an exploded perspective view illustrating an electronic device according to an embodiment of the present disclosure.

Throughout the drawings, like reference numerals will be understood to refer to the same or like parts, components, and structures.

### DETAILED DESCRIPTION

Hereinafter, various embodiments of the present disclosure are described with reference to the accompanying drawings. However, it should be appreciated that the present disclosure is not limited thereto, and rather, the present disclosure includes various modifications, equivalents, and/or alternatives thereto. Similar reference denotations may be used to refer to similar elements throughout the drawings.

In various embodiments of the present disclosure, the terms “have,” “include,” and “comprise” are used to indicate the presence of corresponding features (e.g., numbers, functions, operations, or elements or parts) without excluding the presence of additional features.

In various embodiments of the present disclosure, the terms “A or B,” “at least one of A or/and B,” or “one or more of A or/and B” may encompass all possible combinations of the enumerated items. For example, “A or B,” “at least one of A and B,” or “at least one of A or B” may denote all of (1) including at least one A, (2) including at least one B, or (3) including at least one A and at least one B.

As used herein, the terms “first” and “second” may be used to denote various elements regardless of order and/or priority, and are used only to distinguish one element from another without limiting the elements thereto. For example, a first user device and a second user device may denote different user devices regardless of order or priority. For example, a first element may be denoted a second element and vice versa without departing from the scope of the present disclosure.

When an element (e.g., a first element) is (functionally or communicatively) coupled or connected with/to another element (e.g., a second element), the element may be directly coupled or connected to/with the other element or other elements may intervene. In contrast, when the element is directly coupled or connected to or with the other element, no other element intervenes.

The terms as used herein are used only to describe particular embodiments and are not intended to limit the scope of other embodiments. A singular form may include a plural form unless stated otherwise. All of the technical or scientific terms used herein may be appreciated to have the same meaning as those normally understood by one skilled in the art. Among the terms used herein, the terms defined in the dictionary should not be construed in an overly formal or ideal manner unless defined otherwise. In some cases, the terms defined herein may be interpreted to exclude embodiments of the present disclosure.

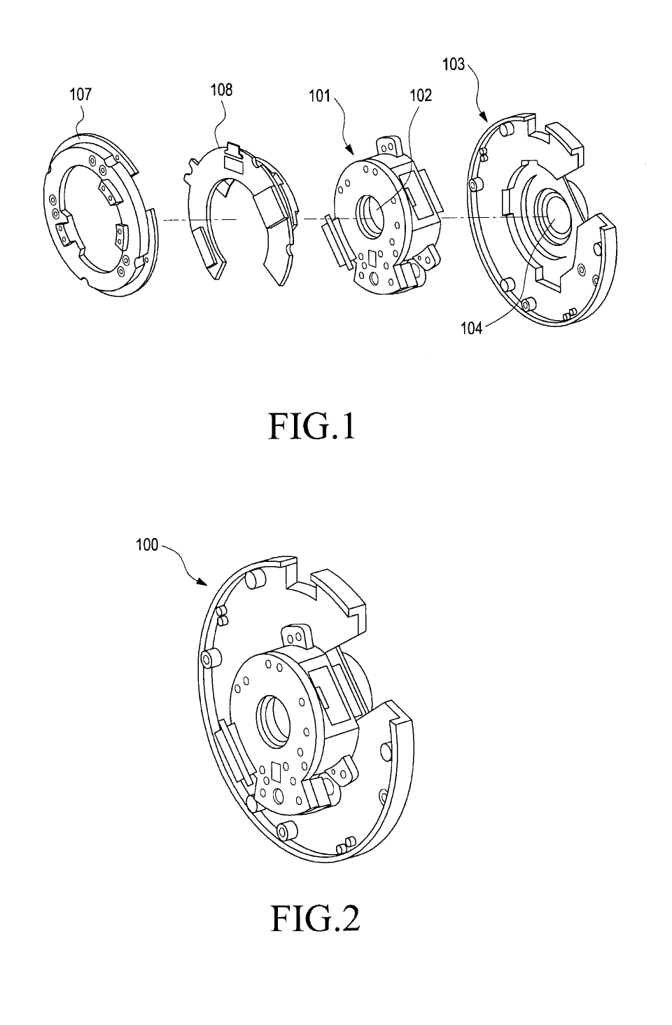

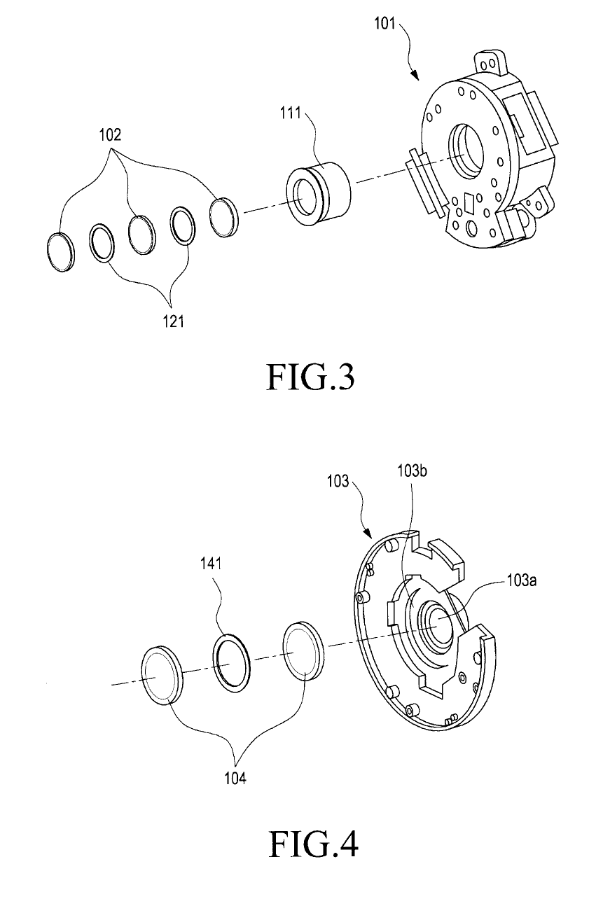

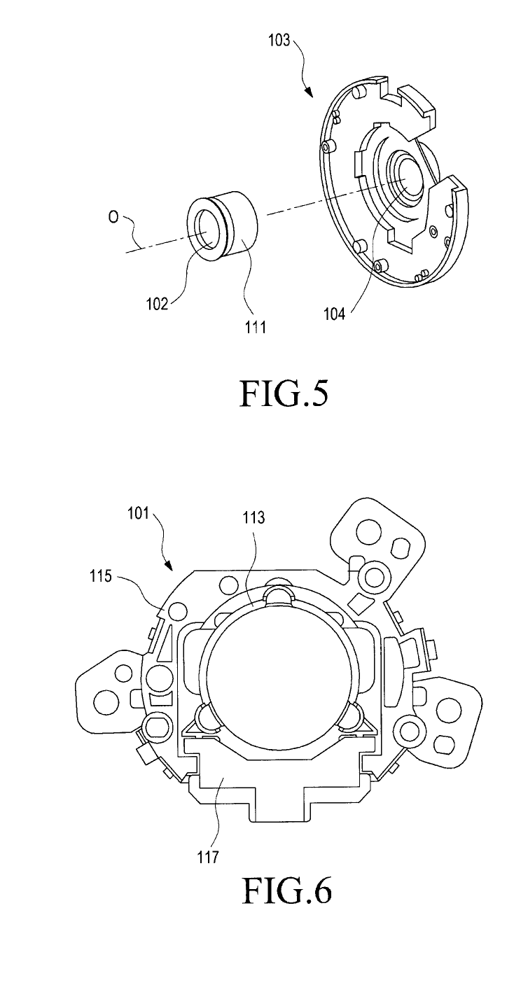

FIG. 1 is an exploded perspective view illustrating a lens barrel according to an embodiment of the present disclosure. FIG. 2 is a perspective view illustrating an example in which a lens barrel is assembled according to an embodiment of the present disclosure. FIG. 3 is an exploded perspective view illustrating a first lens assembly of a lens barrel according to an embodiment of the present disclosure. FIG. 4 is an exploded perspective view illustrating a second lens assembly of a lens barrel according to an embodiment of the present disclosure. FIG. 5 is a perspective view illustrating an example in which a first lens assembly and second lens assembly of a lens barrel are arranged in an optic axis direction according to an embodiment of the present disclosure.

Referring to FIGS. 1 to 5, according to an embodiment of the present disclosure, the lens barrel 100 may include a first lens assembly 101, a second lens assembly 103, a circuit portion 108, and/or a cover mount 107. The lens barrel 100 may be detachably coupled or connected to a capturing device. The capturing device may be an electronic device having a camera and an image sensor obtaining images of an object.

The first lens assembly 101 may include a lens fixing portion 111 having first lenses 102 mounted therein and first rings 121 disposed between the first lenses 102. The first lenses 102 may be formed of a transparent material, such as, a crystal, glass or plastic, for example. The lens fixing portion 111 may be shaped as a cylinder, and the inner diameter of the lens fixing portion 111 may correspond to the outer diameter of the first lenses 102. The outer diameter of the first rings 121 may correspond to the outer diameter of the first lenses 102. The first lenses 102, together with the first rings 121, may be inserted and fastened in the lens fixing portion 111. As the first rings 121 are provided between the first lenses 102, the distance between the first lenses 102 may correspond to the thickness of the first rings 121. The lens fixing portion 111 may be moveably accommodated in the first lens assembly 101. The first lenses 102 mounted in the lens fixing portion 111 may move along the direction of an optic axis (O) (FIG. 5) in the first lens assembly 101. The second lens assembly 103 may have a hole 103a where second lenses 104 are mounted. The inner diameter of the hole 103a may correspond to the outer diameter of the second lenses 104 so that the second lenses 104 may be fitted and coupled to the hole 103a. The second lenses 104 may be formed of a transparent material, such as, a crystal, glass or plastic, for example. The second lens assembly 103 may have a second ring 141 disposed between the second lenses 104. The second lenses 104, together with the second ring 141, may be inserted and fastened in the hole 103a. The second lens assembly 103 may be coupled to the first lens assembly 101 so that the first lenses 102 and the second lenses 104 may be arranged along the optic axis (O). The second lens assembly 103 may have a seating portion 103b that has a shape corresponding to a portion of the first lens assembly 101, e.g., a portion where the first lens assembly 101 faces the second lens assembly 103. The first lens assembly 101, after having been seated on the seating portion 103b, may be bolted to the second lens assembly 103.

The first lenses 102 mounted in the lens fixing portion 111 may move along the optic axis (0) and change their positions relative to the second lenses 104, thereby allowing the lens barrel to performing zooming and focusing.

The circuit portion 108 may process current or control signals transferred to an adjusting portion that is described below. The circuit portion 108 is described below in detail with reference to the drawings.

The cover mount 107 may be coupled with the second lens assembly 103 to provide a space for accommodating the first and second lens assemblies 101 and 103 and the circuit portion 108. The cover mount 107 may be formed of plastic or metal, and together with the second lens assembly 103, may protect the first and second lens assemblies 101 and 103 and the circuit portion 108.

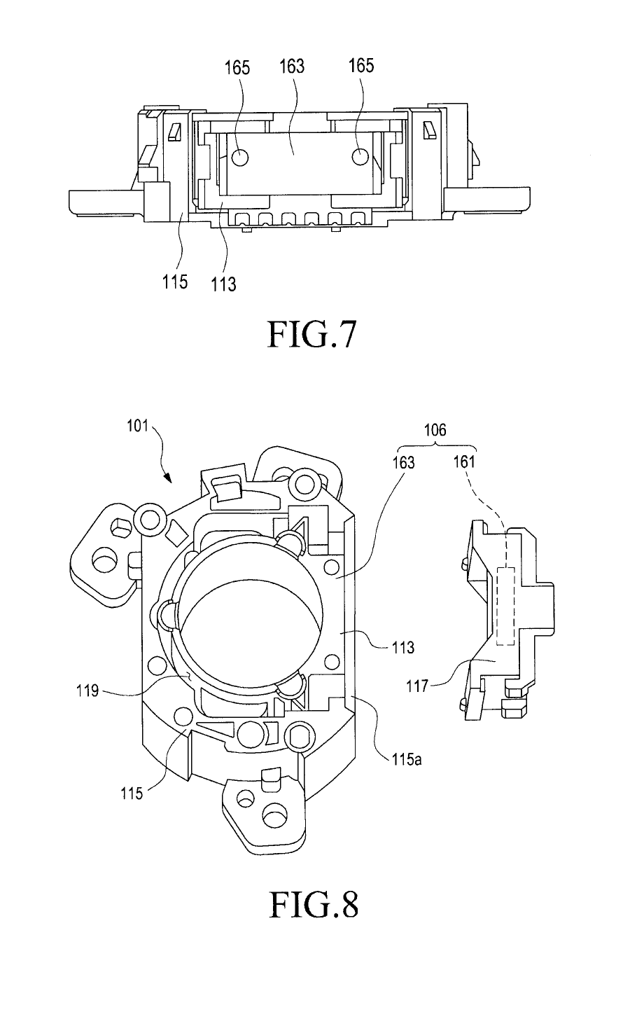

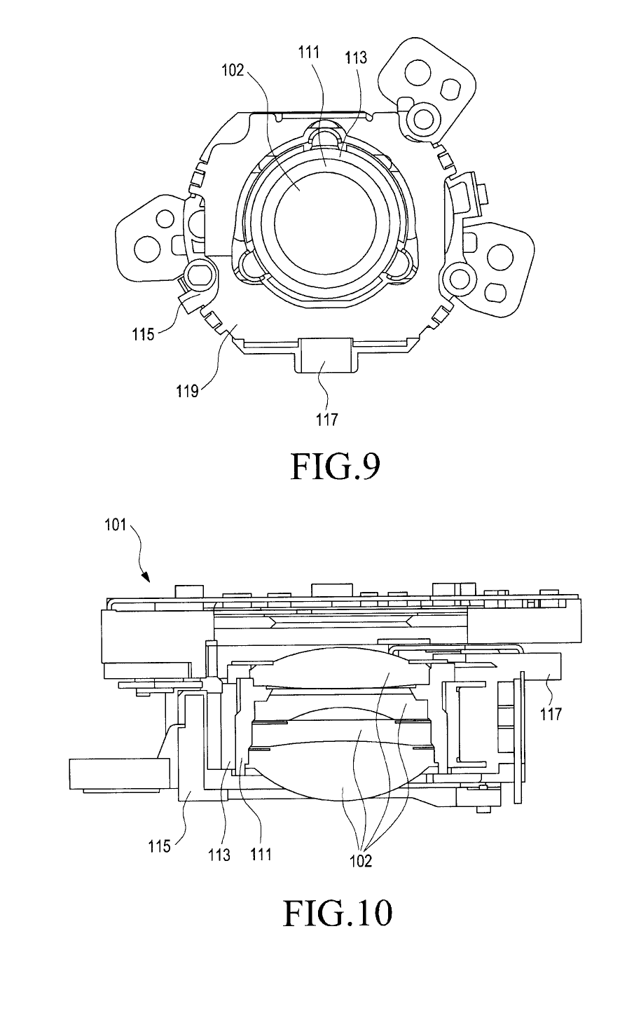

FIG. 6 is a plan view illustrating a first lens assembly of a lens barrel according to an embodiment of the present disclosure. FIG. 7 is a front view illustrating a first lens assembly of a lens barrel according to an embodiment of the present disclosure. FIG. 8 is a perspective view illustrating an example in which a guide portion is separated from a first lens assembly of a lens barrel according to an embodiment of the present disclosure. FIG. 9 is a plan view illustrating an example in which a first lenses are assembled in a first lens assembly of a lens barrel according to an embodiment of the present disclosure. FIG.

10 is a cross-sectional view illustrating a first lens assembly of a lens barrel according to an embodiment of the present disclosure.

Referring to FIG. 6, according to an embodiment of the present disclosure, the first lens assembly 101 of the lens barrel may include a lens module 113, a housing 115, and a guide portion 117.

The lens module 113 may accommodate the lens fixing portion 111 having the first lenses 102 mounted therein. The outer diameter of the lens fixing portion 111 may correspond to the inner diameter of the lens module 113 such that the lens fixing portion 111 may remain fastened to the lens module 113.

The housing 115 may accommodate the lens module 113 to be moveable along the direction of the optic axis (O, FIG. 5) so that the first lenses 102 may move back and forth in the housing 115. A side of the housing 115 may have a first opening 115a through which a portion of the lens module 113 may communicate with the outside of the housing 115.

The guide portion 117 may be coupled to the first opening 115a of the housing 115, and a surface of the guide portion 117 may abut the lens module 113. For example, as the guide portion 117 is inserted through the first opening 115a and moves, the lens module 113, together with the guide portion 117, may be moved in the housing 115. By changing the position of the lens module 113, the slope of the first lenses 102 mounted in the lens module 113, e.g., the slope of the first lenses 102 relative to the bottom of the housing 115 may be finely adjusted. Further, the relative position of the first lenses 102 to the second lenses 104 may be adjusted.

Further, according to an embodiment of the present disclosure, the lens barrel may include an adjusting portion 106 that adjusts the position of the first lenses 102 relative to the second lenses 104 along the direction of the optic axis (O, FIG. 5). The adjusting portion 106 may include a magnet 163 mounted on an outer wall of the lens module 113 and a coil 161 mounted on the guide portion 117. The coil 161 may receive current to generate an electromagnetic force, and the electromagnetic force generated from the coil 161 may force the magnet 163 to move the lens module 163 having the magnet 163 mounted thereon.

For example, as a first current is supplied to the coil 161, the lens module 113 may be moved in a first direction in the housing 115 by a first electromagnetic force generated by the first current. In contrast, as a second current is supplied to the coil 161, the lens module 113 may be moved in a second direction, which is an opposite direction of the first direction, in the housing 115 by a second electromagnetic force generated by the second current. That is, as the first current or the second current is alternatively supplied to the first coil 161, the lens module 113 may be moved back and forth in the housing 115 to adjust the relative position between the first lenses 102 and the second lenses 104.

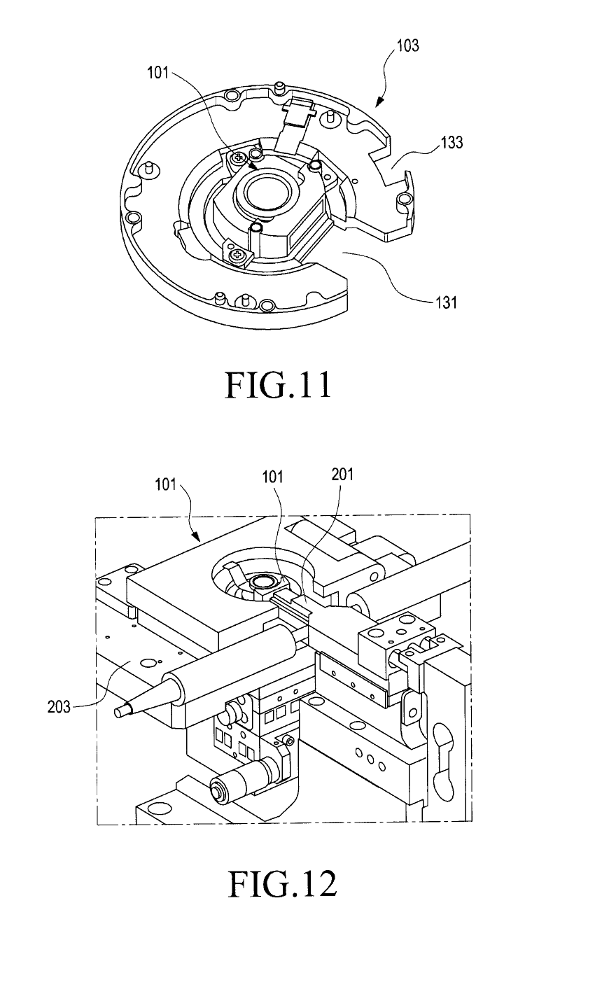

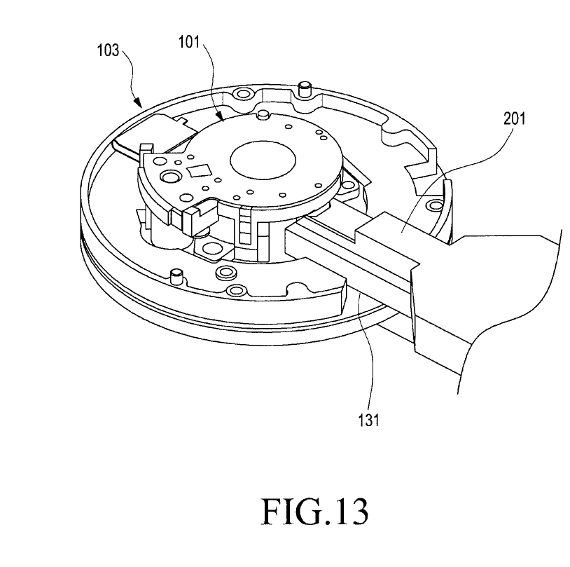

FIG. 11 is a perspective view illustrating an example a first lens assembly is assembled with a second lens assembly of a lens barrel according to an embodiment of the present disclosure. FIG. 12 is a perspective view illustrating an example in which an aligning device is coupled to a first lens assembly of a lens barrel according to an embodiment of the present disclosure. FIG. 13 is a perspective view illustrating an example in which an arm of the aligning device of FIG. 12 is inserted through a first opening of a second lens assembly.

Referring to FIGS. 11 to 13, a method for adjusting the position of the first lens assembly 101 relative to the second lens assembly 103 is described.

After seated on the second lens assembly 103, the first lens assembly 101 may be bolted to the second lens assembly 103. Here, while the first lens assembly 101 is bolted to the second lens assembly 103, the first lenses 102 (FIG. 5) may be arranged along a different optic axis than the optic axis of the second lenses 104 (FIG. 5).

In order to align the optic axes of the first lenses 102 (FIG. 5) and the second lenses 104 (FIG. 5), the aligning device 200 may adjust and align the position of the first lens assembly 101 relative to the second lens assembly 103. The aligning device 200 may include a seating surface 203 where the second lens assembly 103 is seated and an arm 201 holding the first lens assembly 101.

Further, according to an embodiment of the present disclosure, the lens barrel may further include a second opening 131. The second opening 131 may provide a path through which the arm 201 of the aligning device 200 may be inserted.

First, the second lens assembly 103 where the first lens assembly 101 may be seated may be disposed on the seating surface 203 of the aligning device 200 and may be then fastened.

The arm 201 of the aligning device 200 may be inserted through the second opening 131 to be attached to an outer wall 163 (FIG. 7) of the guide portion 113 (FIG. 7) of the first lens assembly 101. Further, the outer wall 163 (FIG. 7) of the guide portion may have guide holes 165, and the arm 201 of the aligning device may have guide protrusions corresponding to the guide holes 165 (FIG. 7). The guide holes 165 may guide the aligning device 200 to the position where the aligning device 200 holds the first lens assembly 101. The arm 201 of the aligning device may be attached to the outer wall 163 (FIG. 7) of the guide portion by air discharge.

The arm 201 of the aligning device may be moved up/down/left/right while holding the guide portion 113 (FIG. 7) to change the position of the first lenses 102 (FIG. 5) so that the optic axis (O, FIG. 5) of the first lenses 102 (FIG. 5) is aligned with the optic axis (O, FIG. 5) of the second lenses 104 (FIG. 5). For example, when the first lenses 102 (FIG. 5) are arranged on an optic axis different from the optic axis of the second lenses 104 (FIG. 5) while the first lens assembly 101 and the second lens assembly 103 are bolted together, the aligning device 200 may be used to change the position of the guide portion 113 (FIG. 7) and to resume the bolting between the first lens assembly 101 and the second lens assembly 103. If such bolting and relocation of the guide portion 101 are repeatedly performed so that the optic axis (O) (FIG. 5) of the first lenses 102 (FIG. 5) is aligned with the optic axis (O, FIG. 5) of the second lenses 104 (FIG. 5), an adhesive may be applied into a space between the guide portion 113 (FIG. 7) and the housing 115 (FIG. 7), allowing the guide portion 113 (FIG. 7) to be fastened to the housing 115 (FIG. 7).

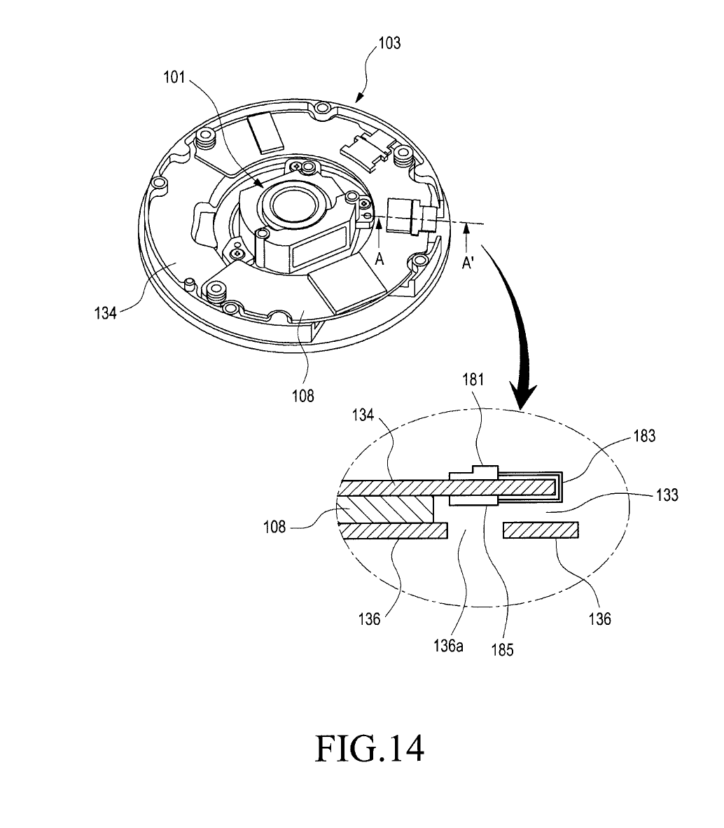

FIG. 14 is a perspective view illustrating an example in which a circuit portion is assembled to a second lens assembly of a lens barrel according to an embodiment of the present disclosure; and

Referring to FIG. 14, according to an embodiment of the present disclosure, the lens barrel may include a circuit portion 108, a third opening 133, and connecting portions 181, 183, and 185.

The circuit portion 108 may be disposed on a surface 134 of the second lens assembly 103, e.g., an inner surface 134 where the second lens assembly 103 faces the cover mount 107, and thus, the size of the lens barrel may be reduced as compared with when the circuit portion 108 is disposed on an opposite surface 136 of the surface 134 of the second lens assembly 103. The circuit portion 108 may be disposed in parallel with the first lens assembly 101 in the second lens assembly 103. The circuit portion 108 may drive the adjusting portion 106 (FIG. 8) to change the relative position of the first lenses 102 (FIG. 5) to the second lenses 104 (FIG. 5).

The third opening 133 may be formed in the second lens assembly 103 to allow the second lens assembly 103 to communicate to the front and back.

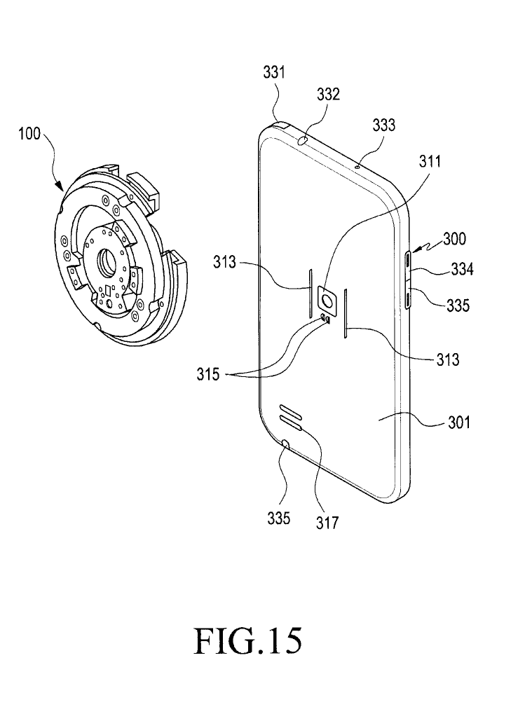

The connecting portions 181, 183, and 185 may electrically connect an electronic device 300 (FIG. 15), as described below, to the circuit portion 108 through the third opening 133. The connecting portions may include a first connecting portion 181, a second connecting portion 185, and a connecting line 183. The first connecting portion 181 may connect to the circuit portion 108 disposed on the surface 134 of the second lens assembly, and the second connecting portion 185 may be disposed on the opposite surface 136 of the second lens assembly. The connecting line 183 may electrically connect the first connecting portion 181 with the second connecting portion 185 via the third opening 133. Accordingly, although the circuit portion 108 may be disposed on the surface 134 of the second lens assembly, the circuit portion 108 may be electrically connected to the electronic device 300 (FIG. 15) facing the opposite surface 136 of the second lens assembly by way of the connecting portions 181, 183, and 185 passing through the third opening.

FIG. 15 is an exploded perspective view illustrating an electronic device according to an embodiment of the present disclosure. Here, the electronic device may also be referred to as a terminal, a portable terminal, a mobile terminal, a communication terminal, a portable communication terminal, a portable mobile terminal, or a display device.

For example, the electronic device may be a digital camera, a smartphone, a mobile phone, a navigation device, a game device, a TV, an automobile head unit, a laptop computer, a tablet computer, a personal media player (PMP), or a personal digital assistant (PDA).

The electronic device may be implemented as a pocket-sized portable communication terminal having a radio communication functionality. Further, the electronic device may be a flexible device or flexible display device. The electronic device may communicate with an external electronic device such as a server or interwork with the external electronic device to perform tasks. For example, the electronic device may transmit images captured by a camera and/or location information detected by a sensor to the server via a network. The network may include, but is not limited to, a mobile or cellular communication network, a local area network (LAN), a wireless local area network (WLAN), a wide area network (WAN), Internet, or a small area network (SAN). In this embodiment, the electronic device is a smartphone, for example.

Referring to FIG. 15, the electronic device 300 may include a casing 301 formed of metal or plastic. A display device (not shown) may be disposed on the front surface of the electronic device 300. A terrestrial digital media broadcast (DMB) antenna 331 for receiving broadcasts, an earphone connection jack 332, a microphone 333, a volume-up button 334, and a volume-down button 335 may be disposed on a side surface of the electronic device 300. An input device receiving portion for receiving an input device (e.g., a digital pen) may be formed on a lower and side surface of the electronic device 300. A camera 311, a coupler 313 for coupling with the lens barrel 100, and a connection terminal 315 for electrical connection with the lens assembly 100 may be disposed on the back surface of the electronic device 300.

The coupler 313 may be formed of a slit to provide a space for insertion of a portion of the lens assembly 100. The portion of the lens barrel 100 may be formed of an elastic material, bent and inserted into an inside of the coupler 313, and constrained by the coupler 313, so that the lens barrel 100 may be fastened to the casing 301. On the other hand, the portion of the lens barrel 100 may be removed from the coupler 313 so that the lens barrel 100 may be detached from the casing 301.

The connection terminal 315 may be disposed on an outer surface of the casing 301, e.g., a surface positioned parallel with the camera 311 disposed in the casing 301. The connection terminal 315 may be an elastic member, such as a c-clip. The connection terminal 315 may be electrically connected with the third connecting portion 185 to transfer current or control signals from the electronic device 300 to the circuit portion 108 (FIG. 14).

As set forth above, according to an embodiment of the present disclosure, a lens barrel may be detachably coupled to a capturing device, the lens barrel comprising: a first lens assembly having at least one first lens mounted therein; a second lens assembly coupled with the first lens assembly and having at least one second lens mounted therein, the at least one second lens being aligned with the at least one first lens along an optic axis, wherein the first lens assembly includes an adjusting portion, the adjusting portion being configured to adjust a position of the at least one first lens relative to the at least one second lens along the optic axis by an electromagnetic force.

According to an embodiment of the present disclosure, the first lens assembly may comprise a lens module having the first lenses mounted therein, a housing accommodating the lens module to be moveable along the direction of the optic axis and having a first opening at a side thereof, and a guide portion coupled to the first opening of the housing.

According to an embodiment of the present disclosure, the adjusting portion may comprise a magnet mounted on an outer wall of the lens module and a coil mounted on the guide portion, and the lens module may be moved in the housing by an electromagnetic force generated by the magnet and the coil.

According to an embodiment of the present disclosure, the lens barrel may further comprise a second opening formed in the second lens assembly, and a position of the first lens assembly relative to the second lens assembly may be adjusted and aligned by an aligning device inserted through the second opening.

According to an embodiment of the present disclosure, the first lens assembly may include at least one of a guide hole and a guide protrusion, and the guide hole or the guide protrusion may guide the aligning device to a position where the aligning device holds the first lens assembly.

According to an embodiment of the present disclosure, the lens barrel may further comprise a circuit portion provided in the second lens assembly to drive the adjusting portion.

According to an embodiment of the present disclosure, the lens barrel may further comprise a third opening formed in the second lens assembly and a connecting portion electrically connecting an electronic device with the circuit portion through the third opening.

The circuit portion may be disposed in parallel with the first lens assembly in the second lens assembly.

According to an embodiment of the present disclosure, an electronic device may comprise the lens barrel.

According to an embodiment of the present disclosure, the electronic device may further comprise a casing, and the lens barrel may be detachably provided to the casing.

According to an embodiment of the present disclosure, the electronic device may further comprise a connection terminal disposed on an outer surface of the casing, and the connection terminal may be electrically connected with the lens barrel.

As is apparent from the foregoing description, according to embodiments of the present disclosure, the lens barrel may adjust the relative position of the first lenses to the second lenses by an electromagnetic force, allowing the lens barrel a compact size. According to embodiments of the present disclosure, the lens barrel may adjust the relative position of the first lenses to the second lenses by an electromagnetic force, allowing more precise zooming.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A lens barrel detachably coupled to a capturing device, the lens barrel comprising:
a first lens assembly having at least one first lens mounted therein; and
a second lens assembly coupled with the first lens assembly and having at least one second lens mounted therein, the at least one second lens being aligned with the at least one first lens along an optic axis,
wherein the first lens assembly includes an adjusting portion, the adjusting portion being configured to adjust a position of the at least one first lens relative to the at least one second lens along the optic axis by an electromagnetic force.

2. The lens barrel of claim 1, wherein the first lens assembly comprises:
a lens module having the at least one first lens mounted therein;
a housing accommodating the lens module and configured to facilitate movement of the lens module along the direction of the optic axis and having a first opening at a side thereof; and
a guide portion coupled within the first opening of the housing.

3. The lens barrel of claim 2, wherein the adjusting portion comprises:
a magnet mounted on an outer wall of the lens module; and
a coil mounted on the guide portion, wherein the lens module is movable in the housing by an electromagnetic force generated by the magnet and the coil.

4. The lens barrel of claim 1, further comprising a second opening formed in the second lens assembly, and an aligning device positioned within the second opening that is configured to adjust and align a position of the first lens assembly relative to the second lens.

5. The lens barrel of claim 4, wherein the first lens assembly includes at least one of a guide hole and a guide protrusion, and wherein the least one of the guide hole and the guide protrusion guides the aligning device to a position where the aligning device holds the first lens assembly.

6. The lens barrel of claim 1, further comprising a circuit portion provided in the second lens assembly to drive the adjusting portion.

7. The lens barrel of claim 6, wherein the circuit portion is disposed between parallel surfaces of the first lens assembly of the second lens assembly.

8. The lens barrel of claim 6, further comprising:
a third opening formed in the second lens assembly; and
a connecting portion electrically connecting an electronic device with the circuit portion through the third opening.

9. An electronic device comprising a lens barrel detachably coupled to a capturing device, the lens barrel comprising:
a first lens assembly having at least one first lens mounted therein; and
a second lens assembly coupled with the first lens assembly and having at least one second lens mounted therein, the at least one second lens being aligned with the at least one first lens along an optic axis,
wherein the first lens assembly includes an adjusting portion, the adjusting portion being configured to adjust a position of the at least one first lens relative to the at least one second lens along the optic axis by an electromagnetic force.

10. The electronic device of claim 9, wherein the first lens assembly comprises:
a lens module having the at least one first lens mounted therein;
a housing accommodating the lens module and configured to facilitate movement of the lens module along the direction of the optic axis and having a first opening at a side thereof; and
a guide portion coupled within the first opening of the housing.

11. The electronic device of claim 10, wherein the adjusting portion comprises:
a magnet mounted on an outer wall of the lens module; and
a coil mounted on the guide portion, wherein the lens module is movable in the housing by an electromagnetic force generated by the magnet and the coil.

12. The electronic device of claim 9, further comprising a second opening formed in the second lens assembly, and an aligning device positioned within the second opening that is configured to adjust and align a position of the first lens assembly relative to the second lens.

13. The electronic device of claim 12, wherein the first lens assembly includes at least one of a guide hole and a guide protrusion, and wherein the least one of the guide hole and the guide protrusion guides the aligning device to a position where the aligning device holds the first lens assembly.

14. The electronic device of claim 9, further comprising a circuit portion provided in the second lens assembly to drive the adjusting portion.

15. The electronic device of claim 14, wherein the circuit portion is disposed between parallel surfaces of the first lens assembly of the second lens assembly.

16. The electronic device of claim 14, further comprising:
a third opening formed in the second lens assembly; and
a connecting portion electrically connecting an electronic device with the circuit portion through the third opening.

17. The electronic device of claim 9, further comprising a casing, wherein the lens barrel is detachably coupled to the casing.

18. The electronic device of claim 17, further comprising a connection terminal disposed on an outer surface of the casing, wherein the connection terminal is electrically connected with the lens barrel.
